(19) United States
(12) Patent Application Publication
(10) Pub. No.: US 2021/0162946 A1
(43) Pub. Date: Jun. 3, 2021

(54) DEVICE AND METHOD FOR DETECTING WHETHER A SEATBELT IS BEING WORN

(71) Applicant: ZF AUTOMOTIVE GERMANY GMBH, Alfdorf (DE)

(72) Inventors: Boris Siebeck, Schwäbisch Gmünd (DE); Frederic Michel, Schwäbisch Gmünd (DE)

(21) Appl. No.: 17/045,185

(22) PCT Filed: Apr. 4, 2019
(86) PCT No.: PCT/EP2019/058467

§ 371 Date: Oct. 5, 2020

(30) Foreign Application Priority Data
Apr. 9, 2018 (DE) 10 2018 108 275.4

(51) Int. Cl. B60R 22/48; B60N 2/00

(52) U.S. Cl. CPC B60R 22/48; B60R 2022/4816; B60N 2/002

(57) ABSTRACT

A device (10) for detecting a belted condition for a seat belt system (12) of a motor vehicle (14) is presented. The device (10) comprises at least one transceiver (24) for electromagnetic waves as well as a transponder (28) and a controller (30). The first transceiver (24) is disposed, when viewed in the vehicle longitudinal direction (L), in front of or behind the sitting position of a vehicle occupant (16) and is connected to the controller (30) so as to transmit signals. The transponder (28) is arranged on webbing of the seat belt system (12) associated with the vehicle seat (19) and is configured to receive and automatically respond to scanning signals of the transceiver (24). The controller (30) is configured to detect, based on output signals of the first transceiver (24), whether the vehicle occupant (16) has correctly fastened the seat belt (18). Furthermore, a method for detecting a belted condition is suggested.

### RELATED APPLICATIONS

This application corresponds to PCT/EP2019/058467, filed Apr. 4, 2019, which claims the benefit of German Application No. 10 2018 108 275.4, filed Apr. 9, 2018, the subject matter of which are incorporated herein by reference in their entirety.

### BACKGROUND OF THE INVENTION

The invention relates to a device for detecting a belted condition for a seat belt system of a motor vehicle and to a method for detecting a belted condition for such seat belt system.

For correctly adjusting an airbag safety system, it is important whether or not a vehicle occupant is correctly belted, i.e. whether, in the case of crash, the seat belt restrains the vehicle occupant in defined manner. For example, when a vehicle occupant is belted, the airbag safety system is not released before the vehicle is significantly accelerated. In addition, a gas filling amount of the airbag safety system by which an airbag of the airbag safety system is inflated may depend on whether or not the vehicle occupant is belted.

When the vehicle occupant passes the seat belt behind his/her body or behind the vehicle seat, for example, and inserts a latch tongue of the seat belt into the associated belt buckle, it is not sufficient to merely detect the latch tongue inserted in the belt buckle for detecting correct fastening of the seat belt and actually efficient belting of the vehicle occupant, respectively, for which the seat belt provides the desired restraining function.

Also, the vehicle occupant can bypass belt buckle detection by inserting a wrong latch tongue, for example a latch tongue of a different seat belt that is not associated with the belt buckle (especially in the uncoded case) or a (possibly coded) latch tongue that is separately configured.

### SUMMARY OF THE INVENTION

Therefore, it is the object of the invention to provide a device and a method for detecting a belted condition by means of which it can be reliably detected whether a vehicle occupant has correctly fastened the seat belt.

According to the invention, the object is achieved by a device for detecting a belted condition for a seat belt system of a motor vehicle, comprising at least one first transceiver for electromagnetic waves as well as a transponder and a controller, wherein the first transceiver, when viewed in the vehicle longitudinal direction, is disposed in front of or behind the seated position of a vehicle occupant and is connected to the controller so as to transmit signals, wherein the transponder is disposed on webbing of the seat belt system associated with the vehicle seat and is configured to receive and automatically respond to scanning signals of the transceiver, and wherein the controller is configured to detect, based on output signals of the first transceiver, whether the vehicle occupant has correctly fastened the seat belt. The transponder, sometimes also referred to as radio tag, and the transceiver especially are an RFID (radio-frequency identification) system. The transponder responds to the scanning signals of the transceiver in a predefined manner only when the vehicle occupant has correctly fastened the seat belt. By means of the device according to the invention, it can thus be reliably detected whether the seat belt is correctly fastened.

The device according to the invention is based on the fundamental idea to exploit the absorption of electromagnetic waves by the human body for detecting a belted condition. Accordingly, the transceiver and the transponder are transmitting in a wavelength range in which electromagnetic waves are properly absorbed by the human body that primarily consists of water. The transceiver and the transponder are arranged so that the transponder will respond only when the seat belt is correctly fastened (or else will not respond). For example, the transceiver is arranged in the area of the instrument panel. The transponder disposed in the seat belt responds to a scanning signal of the transceiver only when the vehicle occupant has passed the seat belt in front of the body, which corresponds to correct fastening of the seat belt. If the vehicle occupant had passed the seat belt behind his/her body, then the vehicle occupant would absorb the scanning signals. Alternatively, the transceiver may also be disposed in the vehicle seat. In such case, the transponder would respond to the scanning signal of the transceiver when the seat belt is not correctly fastened (i.e. is passed behind the vehicle occupant), although this should definitely not be possible when the seat belt is correctly fastened. Thus, in both cases, a correctly fastened seat belt can be detected from whether or not the transponder responds.

The transceiver is provided especially directly in front of or directly behind the sitting position, for example in or at the vehicle seat or in the area of the instrument panel. The sitting position may be the sitting position of the driver, the passenger or else a sitting position on a rear bench seat of the motor vehicle. In particular, the at least one transceiver and/or the transponder is/are designed so that a main emitting and/or receiving direction for electromagnetic waves is substantially orientated in the vehicle longitudinal direction.

One aspect intends a second transceiver for electromagnetic waves to be provided which faces the first transceiver, the second transceiver being connected to the controller so as to transmit signals. The controller is especially configured to detect, on the basis of output signals of the second transceiver, whether the vehicle occupant has correctly fastened the seat belt. Preferably, the two transceivers are located on different sides of the sitting position relating to the vehicle longitudinal direction. Thus, the term facing in this case means that between the two transceivers the vehicle occupant is located, if he/she takes a seat in the respective vehicle seat. In this variant, the response signals of the transponder to the scanning signals of the two transceivers allow to detect especially reliably whether the vehicle occupant has correctly fastened the seat belt. Especially in this configuration of the invention, also a situation can be detected in which the seat belt is not extended and a latch tongue is inserted in the belt buckle which actually is not associated with said belt buckle. This may be a separate latch tongue (“cheating tongue”) or a latch tongue associated with a different seat. Since the transponder in the non-extended seat belt does not respond either to the scanning signal of the first transceiver or to the scanning signal of the second transceiver, such situation can be detected especially reliably by means of the two transceivers.

According to another aspect, the first transceiver and the second transceiver are disposed in the vehicle seat and, resp., in the area of the instrument panel. The first transceiver may also be arranged on the vehicle seat. Especially, the second transceiver is provided in the area of a steering wheel.

In one configuration of the invention, a belt buckle of the seat belt system is configured to detect an inserted latch tongue, especially wherein the belt buckle is connected to the controller so as to transmit signals. Especially, the controller is configured to detect, based on output signals of the belt buckle, whether the driver has correctly fastened the seat belt. In connection with the output signals of the first and/or the second transceiver, it can be determined particularly reliably whether the vehicle occupant has correctly fastened the provided seat belt.

In another configuration of the invention, the transponder is configured as an active transponder. Especially, the transponder and/or the at least one transceiver is/are configured to carry out a changing code method. Alternatively, the transponder may also be a passive transponder.

The transponder can be accommodated in a button cap on the webbing, the button cap being associated with a latch tongue. Since the button cap is provided on the webbing anyway, the transponder thus can be arranged especially easily on the webbing.

According to another aspect, the driver-side or the passenger-side latch tongue comprises a further transponder. Also, each of the driver-side and the passenger-side latch tongue may comprise a further transponder. A belt buckle of the seat belt system can be configured to transmit scanning signals and to receive corresponding response signals of the associated transponder. In this way, it can be directly detected whether the correct latch tongue is inserted in the associated belt buckle. Alternatively, a different coding can be provided. This helps reliably prevent a different latch tongue of the seat belt system which is not associated with the respective seat from being inserted in the belt buckle to deceive the detection of a belted condition. In addition, even the use of latch tongues not belonging to the seat belt system can thus be identified.

In one configuration of the invention, at least one further transceiver and one further transponder associated to a further vehicle seat are provided. Preferably, at least one transceiver and one transponder are associated with both of the driver seat and the passenger seat. Especially, the transceiver and the transponder can be analogously arranged at both seats.

Another aspect provides that at least one seat occupancy mat associated with the vehicle seat or the further vehicle seat is connected to the controller so as to transmit signals. In this way, it can be reliably detected whether the respective seat is occupied, thus allowing to further justify a conclusion of detecting a belted condition.

Furthermore, according to the invention, the object is achieved by a method for detecting a belted condition for a seat belt system of a motor vehicle comprising a seat belt. Initially, an electromagnetic scanning signal is generated by at least one transceiver. Now it is detected whether at least one transponder provided on webbing of the seat belt responds to the electromagnetic scanning signal. On the basis of whether the at least one transponder responds, it is detected whether the vehicle occupant has correctly fastened the seat belt. Then the transponder responds to the scanning signals of the transceiver, if the vehicle occupant is not located between the transceiver and the seat belt and absorbs the signal. Depending on the arrangement of the transceiver, when the seat belt is correctly fastened, a response signal is or is not to be given. By means of the method according to the invention, it can therefore be reliably detected whether the vehicle occupant has correctly fastened the seat belt. As to the further advantages, the foregoing explanations shall be referred to.

One aspect provides that the response of the at least one transponder is received by the transceiver and, on the basis of the response, it is established whether the vehicle occupant has correctly fastened the seat belt. Accordingly, the response may be a predefined response or a response that is established in a changing code method. In other words, it is either merely established whether the transponder responds at all, or also the content of the response signal is established and considered for detecting a belted condition.

According to another aspect, it is additionally established whether a latch tongue is located in a driver-side belt buckle or in a passenger-side belt buckle. When the latch tongue(s) is/are provided with a transponder, also a scanning signal can be generated and the response of the transponder(s) can be evaluated.

In another configuration of the invention, it is established by means of a seat occupancy mat whether a further vehicle seat is occupied. This helps further justify a conclusion of detecting a belted condition.

### BRIEF DESCRIPTION OF THE DRAWINGS

Further advantages and characteristics of the invention will be evident from the following description and the drawings which are referred to, wherein:

FIG. 1 shows a schematic top view of a device according to the invention for detecting a belted condition;

FIG. 2 shows the device for detecting a belted condition of FIG. 1 comprising a modified guidance of a seat belt;

FIG. 3 shows a schematic top view of a second variant of a device according to the invention for detecting a belted condition;

FIG. 4 shows the device for detecting a belted condition of FIG. 3 comprising a modified guidance of a seat belt; and

FIG. 5 shows a schematic flow chart of the steps of a method according to the invention for detecting a belted condition.

### DESCRIPTION

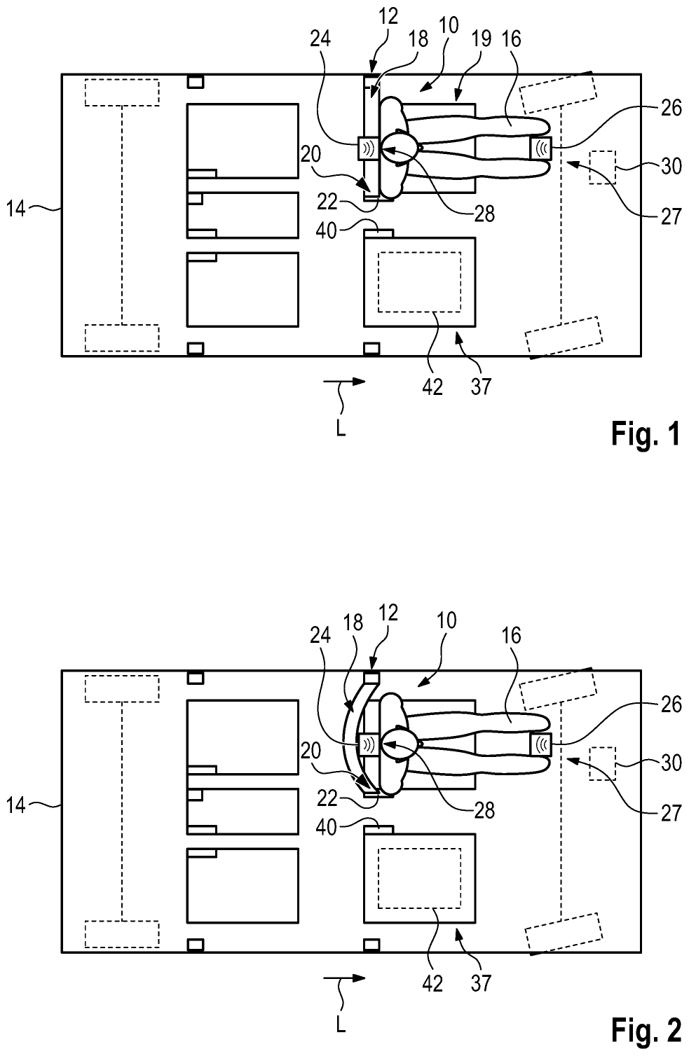

FIG. 1 illustrates a first variant of a device 10 for detecting a belted condition for a seat belt system 12 of a motor vehicle 14.

In the situation shown there, a vehicle occupant 16 has incorrectly fastened a seat belt 18, and in particular webbing of the seat belt 18 extends incorrectly. More exactly speaking, the seat belt 18 is passed, with respect to a vehicle longitudinal direction L, behind the vehicle occupant 16 (between the back of the vehicle occupant 16 and a vehicle seat 19), wherein a latch tongue 20 associated with the seat belt 18 is correctly inserted in an associated belt buckle 22, however.

The device 10 includes a first transceiver 24 and, in the shown variant, additionally a second transceiver 26. The first and second transceivers 24, 26 are arranged, when viewed in the vehicle longitudinal direction L, behind and, resp., in front of a sitting position of the vehicle occupant 16, i.e. facing each other.

More exactly speaking, the first transceiver 24 is associated with, especially integrated in, a backrest of a vehicle seat 19. The second transceiver is disposed in the area of an instrument panel 27, especially in the area of a steering wheel.

In the seat belt 18, a transponder 28 is provided, for example integrated in a button cap of the seat belt 18 which button cap is associated with the latch tongue 20. The transponder 28, sometimes also referred to as radio tag, and the transceivers 24, 26 are especially parts of an RFID system (“radio frequency identification system”).

The two transceivers 24, 26 are connected to a controller 30 so as to transmit signals, especially by means of electric wiring or wirelessly. The controller 30 is, for example, part of the vehicle control system or a control system configured separately herefrom which may be communicated with the higher vehicle control system.

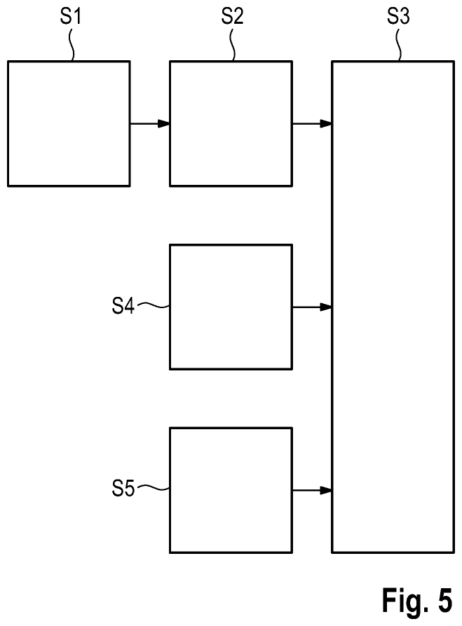

The controller 30 is configured to control the transceivers 24, 26 as well as to receive and evaluate output signals therefrom. Furthermore, the controller 30 is configured to carry out a method for detecting a belted condition described hereinafter by way of FIG. 5.

To start with, a scanning signal is generated by means of at least one of the transceivers 24, 26 (step S1).

If the transponder 28 responds to the scanning signal, the response is received by means of at least one of the transceivers 24, 26 and a respective output signal is transmitted to the controller 30 (step S2).

On the basis of the output signals, it is detected whether the vehicle occupant 16 has correctly fastened the seat belt 18 (step S3).

The detection of a belted condition is based on the principle of absorption. The wavelength of the electromagnetic waves emitted by the transceivers 24, 26 is within a range in which the human body properly absorbs the same, as the human body consists primarily of water.

When the seat belt 18 is correctly fastened, the transponder 28 should appropriately respond to a scanning signal of the second transceiver 26 rather than to a scanning signal of the first transceiver 24.

In the case shown in FIG. 1, the transponder 28 responds to the scanning signal of the first transceiver 24 rather than to that of the second transceiver 26. The controller 30 therefrom detects that the seat belt 18 is not correctly fastened.

It may be provided to output a warning signal when the controller 30 detects that the seat belt 18 is not correctly fastened, similarly to the warning signal for the latch tongue 20 not being inserted.

This applies mutatis mutandis to the situation shown in FIG. 2 in which the seat belt 18 is passed behind the backrest of the vehicle seat 19.

In this case, too, the transponder 28 would respond to the scanning signal of the first transceiver 24 rather than to that of the second transceiver 26, wherefrom the controller 30 establishes that the seat belt 18 is not correctly fastened.

In accordance with one variant, the transponder 28 can be an active transponder. Especially, the transponder 28 then is configured to carry out a changing code method. In this respect, the response signal appropriately changes to impede deliberate bypassing of the detection of the belted condition.

In order to further improve the quality of detecting the belted condition, the belt buckle 22 may be provided for being configured to detect an inserted latch tongue 20 (step S4), for example by means of a corresponding coding of the associated latch tongue 20.

Accordingly, the belt buckle 22 can be connected to the controller 30 so as to transmit a signal. The controller 30 is especially configured to detect, on the basis of output signals of the belt buckle 22, whether the vehicle occupant 16 has correctly fastened the appropriate seat belt 18.

The latch tongue 20 may (equally) be provided with a transponder. Preferably, the belt buckle 22 then is configured to transmit scanning signals and to receive corresponding response signals of the associated transponder of the latch tongue 20.

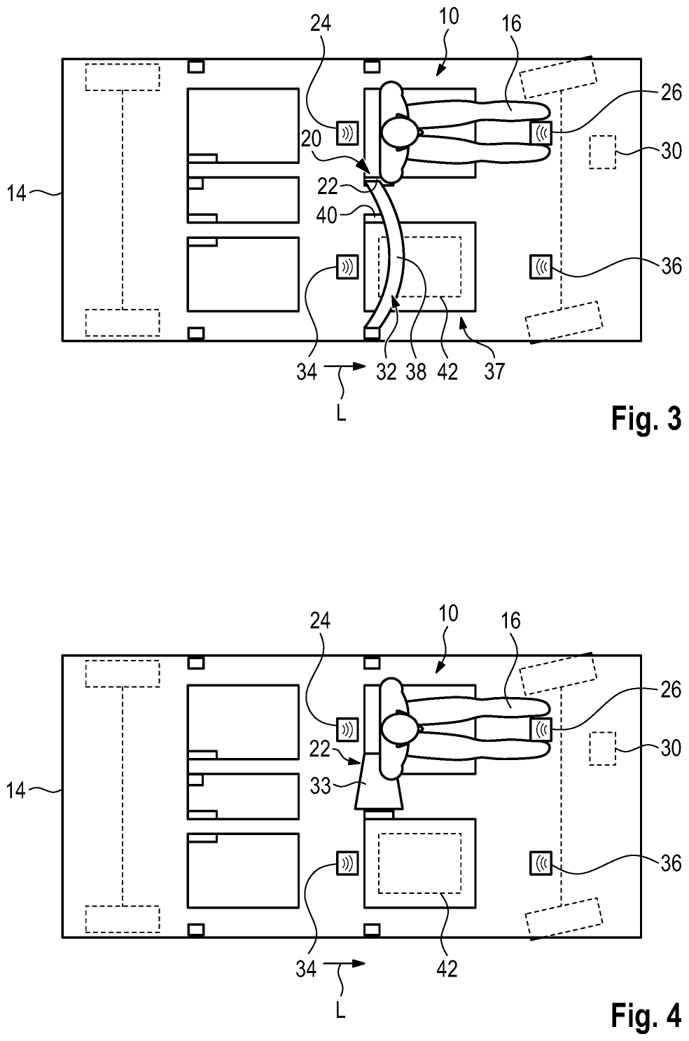

FIGS. 3 and 4 illustrate further situations in which a latch tongue 20 of another seat belt 32 associated with a different place or vehicle seat is inserted in the belt buckle 22 (FIG. 3) or, resp., in which a separate latch tongue 33 (“cheating tongue”) is inserted in the belt buckle 22 (FIG. 4).

In this case, too, the afore-described device 10 helps detect that the seat belt 18 is not correctly fastened, as the transponder 28 does not respond either to the scanning signal of the first transceiver 24 or to that of the second transceiver 26.

As illustrated in FIGS. 3 and 4, there may also be provided further transceivers 34, 36 associated with another vehicle seat 37, in this case the passenger seat. The further transceivers 34, 36 are connected to the controller 30 so as to equally transmit signals.

Moreover, the further seat belt 32, i.e. the seat belt 32 associated with the passenger seat, may comprise a further transponder 38.

In this variant, the incorrect guidance of the seat belt shown in FIG. 3 is doubtlessly evident, as the further transponder 38 responds to the signals of the two further transceivers 34, 36 which are associated with the further vehicle seat 37 or, resp., the passenger seat.

The fact that additionally no latch tongue is inserted in a belt buckle 40 associated with the further vehicle seat 37 is further indicative of situation of incorrect belting.

Furthermore, in this variant the afore-illustrated incorrect belting situations can also be identified for a further vehicle occupant.

For further justifying the results of the detecting a belted condition, output signals of at least one seat occupancy mat 42 associated with the vehicle seat 19 and/or the further vehicle seat 37 can be forwarded to and evaluated by the controller 30 (step S5).

The situations shown in FIGS. 1 to 4 in which the seat belt 32 associated with the vehicle operator's seat is not correctly fastened can be detected already by one transceiver only, for example the second transceiver 26, as the latter should receive a response signal when the seat belt 32 is correctly fastened. Consequently, if the second transceiver 26 receives no response signal, the controller 30 can conclude an incorrectly fastened seat belt 32.

In this respect, it can be detected sufficiently safely already by one transceiver whether or not the seat belt is correctly fastened.

This determination can be further justified, however, by a second transceiver, further transceivers associated with other vehicle seats, a belt buckle identification and/or a seat occupancy mat.

Especially, thus the way in which the seat belt is incorrectly fastened can be detected.

1-13. (canceled)

14. A device (10) for detecting a belted condition for a seat belt system (12) of a motor vehicle (14), comprising at least a first transceiver (24) for electromagnetic waves as well as a transponder (28) and a controller (30),
wherein the first transceiver (24), when viewed in the vehicle longitudinal direction (L), is arranged in front of or behind the sitting position of a vehicle occupant (16) and is connected to the controller (30) so as to transmit signals,
wherein the transponder (28) is disposed on webbing of the seat belt system (12) associated with the vehicle seat (19) and is configured to receive and automatically respond to scanning signals of the transceiver (24), and
wherein the controller (30) is configured to detect, based on output signals of the first transceiver (24), whether the vehicle occupant (16) has correctly fastened the seat belt (18),
wherein a second transceiver (26) for electromagnetic waves facing the first transceiver (24) is provided, the second transceiver (26) being connected to the controller (30) so as to transmit signals,
and wherein the two transceivers (24, 26) are located on different sides of the sitting position relating to the vehicle longitudinal direction.

15. The device (10) according to claim 14, wherein the first transceiver (24) is disposed in the vehicle seat (19) and the second transceiver is disposed in the area of the instrument panel (27).

16. The device (10) according to claim 14, wherein a belt buckle (22) of the seat belt system (12) is configured to detect an inserted latch tongue (20), especially wherein the belt buckle (22) is connected to the controller (30) so as to transmit signals.

17. The device (10) according to claim 14, wherein the transponder (28) is in the form of an active transponder.

18. The device (10) according to claim 14, wherein the transponder (28) is accommodated in a button cap on the webbing which button cap is associated with a latch tongue (20).

19. The device (10) according to claim 14, wherein the driver-side or the passenger-side latch tongue (20) comprises another transponder (38).

20. The device (10) according to claim 14, wherein at least one further transceiver (34, 36) and one further transponder (38) are provided which are associated with another vehicle seat (37).

21. The device (10) according to claim 14, wherein at least one seat occupancy mat (42) associated with the vehicle seat (19) or with the further vehicle seat (37) is connected to the controller (30) so as to transmit signals.

22. A method for detecting a belted condition for a seat belt system (12) of a motor vehicle (14) comprising a seat belt (18, 32), comprising the following steps of:
generating an electromagnetic scanning signal by means of at least one transceiver (24, 26, 34, 36); and
detecting whether at least one transponder (28, 38) provided on webbing of the seat belt (18, 32) responds to the electromagnetic scanning signal;
wherein, on the basis of whether the at least one transponder (28, 38) responds, it is established whether the vehicle occupant (16) has correctly fastened the seat belt (18, 32).

23. The method according to claim 22, wherein the response of the at least one transponder (28, 38) is received by the transceiver (24, 26, 34, 36) and, based on the response, it is established whether the vehicle occupant (16) has correctly fastened the seat belt (18, 32).

24. The method according to claim 22, wherein it is additionally established whether a latch tongue (20) is inserted in a driver-side belt buckle (22) or in a passenger-side belt buckle (40).

25. The method according to claim 22, wherein it is additionally established by means of a seat occupancy mat (42) whether a further vehicle seat is occupied.
